(19) United States
(12) Patent Application Publication
(10) Pub. No.: US 2011/0118920 A1
(43) Pub. Date: May 19, 2011

(54) REGENERATIVE BRAKING TORQUE COMPENSATION DEVICE, METHODS FOR REGENERATIVE BRAKING TORQUE COMPENSATION AND A HYBRID VEHICLE EMBODYING SUCH DEVICES AND METHODS

(75) Inventor: Jeong Eun Kim, Seongnam (KR)

(73) Assignees: HYUNDAI MOTOR COMPANY, Seoul (KR); KIA MOTORS CORPORATION, Seoul (KR)

(21) Appl. No.: 12/846,114

(22) Filed: Jul. 29, 2010

(30) Foreign Application Priority Data
Nov. 17, 2009 (KR) 10-2009-0111113

(51) Int. Cl. G06F 19/00

(52) U.S. Cl. 701/22; 903/947

(57) ABSTRACT

The present invention compensates a regenerative braking amount by applying a target shift step and a shift phase in a case that the vehicle is in deceleration according to a brake demand and regenerative braking is performed. A regenerative braking torque compensation method of a hybrid vehicle may include a step of determining a regenerative braking operation amount to control regenerative braking torque while regenerative braking is needed, a step of applying a real shift ratio to determine a regenerative braking operation amount if shifting is detected during the regenerative braking, a step of applying a target shift step and a shift phase according to the shifting to decide a regenerative braking compensation amount, and a step of applying the regenerative braking operation amount to the regenerative braking compensation amount to control final regenerative braking torque.

### CROSS-REFERENCE TO RELATED APPLICATION

This application claims priority to and the benefit of Korean Patent Application No. 10-2009-0111113 filed in the Korean Intellectual Property Office on Nov. 17, 2009, the entire contents of which are incorporated herein by reference.

### BACKGROUND OF THE INVENTION

(a) Field of the Invention

The present invention relates to a hybrid vehicle, more particularly to a hybrid vehicle embodying regenerative braking techniques and yet more particularly, to a regenerative braking torque compensation device and methods related thereto.

(b) Description of the Related Art

A hybrid vehicle typically includes a reciprocating engine and an electric motor (motor/generator) that is operated by a high voltage battery to assist the engine while the vehicle is being operated. Such an arrangement offers high energy efficiency and low emission through the combination of the two power sources.

When considering power performance, fuel consumption, and drivability for the hybrid vehicle, an automatic transmission is generally provided such that an optimized gear shifting ratio is automatically determined shift gears.

If the automatic transmission is not precisely controlled, however, a shock can be generated therefrom. Thus, the durability of the transmission can be deteriorated. Therefore, while shifting gears it is desirable that impacts be small and the response be fast.

Also, in a hybrid vehicle when a braking is performed using a brake pedal, the motor assisting the output torque of the engine is reconfigured to use the regenerative energy of the braking to charge a battery of the hybrid vehicle.

When a hybrid control unit (HCU) connected to an electric brake system (EBS) through a network detects a brake signal by a pedal stroke and a master cylinder pressure, the HCU calculates a regenerative braking amount or force based on a motor torque and controls the motor/generator to perform regenerative braking according to the calculated amount or force using a motor control unit (MCU).

If regenerative braking is being performed, the hydraulic brakes of the vehicle also are used to supply the remaining braking force or amount necessary for vehicle operation. In particular, the remaining braking amount or force is calculated by subtracting the regenerative braking amount from a total braking amount. The EBS supplies hydraulic pressure to operate the vehicle brakes and to generate the remaining braking amount/force.

FIG. 4 is a graph view that shows a regenerative braking torque control result in a conventional hybrid vehicle.

As shown in FIG. 4, in the case where gear shifting is performed during the regenerative braking of the motor, a calculated regenerative braking amount B1 and a measured regenerative braking amount C1 are different at the same moment with a1, b1, and c1. As a result, the brake feeling becomes rough and the shifting shock is transferred therefrom.

As also shown, the measured regenerative braking amount C1 is larger than the calculated regenerative braking amount B1 at some point of the shifting period. Consequently, braking is excessively performed.

Also, due to the torque fluctuation, the shock occurs, and uniform deceleration is not realized.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention features a regenerative braking torque compensation device and methods related thereto. Such methods include compensating for a regenerative braking amount by applying a target shift step and a shift phase when the vehicle is decelerating according to a brake demand and regenerative braking is performed.

In one aspect of the present invention, there is provided a regenerative braking torque compensation device for a hybrid vehicle. Such a regenerative braking torque compensation device includes: a motor control unit controlling operation torque of a motor; a brake control unit calculating a brake torque to control hydraulic pressure supplied to a brake cylinder of a wheel; and a hybrid control unit that applies a real shift ratio to calculate a regenerative braking amount if gear shifting is detected, and determining a regenerative braking torque compensation amount according to a target shift step and a shift phase to control regenerative braking torque.

In another aspect of the present invention, there is provided a regenerative braking torque compensation method of a hybrid vehicle. Such a method includes: (a) determining a regenerative braking operation amount to control regenerative braking torque while regenerative braking is needed, (b) applying a real shift ratio to determine a regenerative braking operation amount if shifting is detected during the regenerative braking, (c) applying a target shift step and a shift phase according to the shifting to decide a regenerative braking compensation amount, and (d) applying the regenerative braking operation amount to the regenerative braking compensation amount to control final regenerative braking torque.

In the present invention as stated above, excessive braking is prevented during regenerative braking, and continuous braking torque is secured such that the stability and reliability of the hybrid vehicle are enhanced.

Other aspects and embodiments of the present invention are described herein.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships and the like, and includes hybrid vehicles, electric vehicles, plug-in hybrid vehicles, hydrogen powered vehicles and other alternative fuel vehicles (e.g., fuels derived from resources other than petroleum). As referred to herein, a hybrid vehicle is a vehicle that has two or more sources of power, for example both petroleum (e.g., gasoline, diesel) powered and electric powered vehicles.

### BRIEF DESCRIPTION OF THE DRAWINGS

For a fuller understanding of the nature and desired objects of the present invention, reference is made to the following detailed description taken in conjunction with the accompanying drawing figures wherein like reference characters denote corresponding parts throughout the several views and wherein:

FIG. 1 is a schematic view that shows a regenerative braking torque compensation device and a hybrid vehicle according to the present invention.

FIG. 2 is a high level flow diagram of a regenerative braking torque compensation procedure or methodology according to the present invention.

FIG. 3 is a graphical view that shows a regenerative braking torque compensation result of a hybrid vehicle according to an exemplary embodiment of the present invention.

FIG. 4 is a graphical view showing a regenerative braking torque control result in a conventional hybrid vehicle.

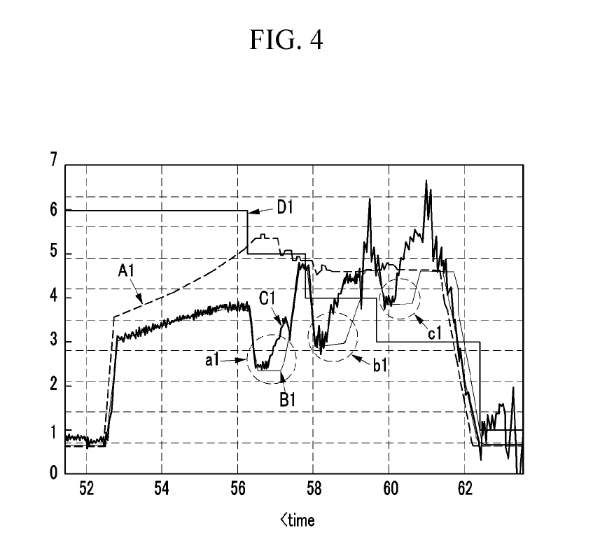

FIG. 5 is a block diagram showing a procedure realizing a regenerative braking torque compensation result according to the present invention.

Reference numerals set forth in the Drawings include reference to the following elements as further discussed herein.

10: ECU

20: HCU

30: MCU

40: battery

50: BMS

60: EBS

70: motor

80: engine

90: engine clutch

100: transmission

110: vehicle speed detector

### DETAILED DESCRIPTION OF THE EMBODIMENTS

In the following detailed description, certain aspects and/or embodiments of the present invention are shown and described, by way of illustration. As those skilled in the art would realize, the described embodiments can be modified in various different ways, all without departing from the spirit or scope of the present invention. The drawings and description are to be regarded as illustrative in nature and not restrictive, and like reference numerals designate like elements throughout the specification.

As described further herein, in one aspect/embodiment of the present invention features regenerative braking torque compensation device for a hybrid vehicle. Such a regenerative braking torque compensation device includes a motor control unit being configured so as to control the operation torque of a motor and a brake control unit being configured to calculate a brake torque which is used to control hydraulic pressure supplied to a brake cylinder of a wheel. Such a device also includes a hybrid control unit being configured to calculate a regenerative braking amount when gear shifting is detected during regenerative braking, and to determine a regenerative braking torque compensation amount used to establish a regenerative braking torque.

According to another aspect/embodiment of the present invention there is featured a regenerative braking torque compensation method of a hybrid vehicle. Such a method includes (a) determining a regenerative braking operation amount to control regenerative braking torque during regenerative braking; (b) if transmission shifting is detected during regenerative braking, determining a regenerative braking operation amount; (c) applying a target shift step and a shift phase to determine a regenerative braking compensation amount; and (d) applying the regenerative braking operation amount to the regenerative braking compensation amount to determine a final regenerative braking torque.

According to yet another aspect/embodiment of the present invention there is featured a hybrid vehicle embodying a regenerative braking torque compensation device according to the present invention. More particularly, such a hybrid vehicle includes an engine, an electric motor that is operably coupled to an output of the engine so as to at least assist the engine during operation of the vehicle and also being capable of regenerative braking, and a regenerative braking torque compensation device.

In further embodiments, such a regenerative braking torque compensation device includes a motor control unit that is configured so as to control the operation torque of a motor and a brake control unit being configured to calculate a brake torque which is used to control hydraulic pressure supplied to a brake cylinder of a wheel. Also included is a hybrid control unit that is configured to calculate a regenerative braking amount when gear shifting is detected during regenerative braking, and to determine a regenerative braking torque compensation amount used to establish a regenerative braking torque.

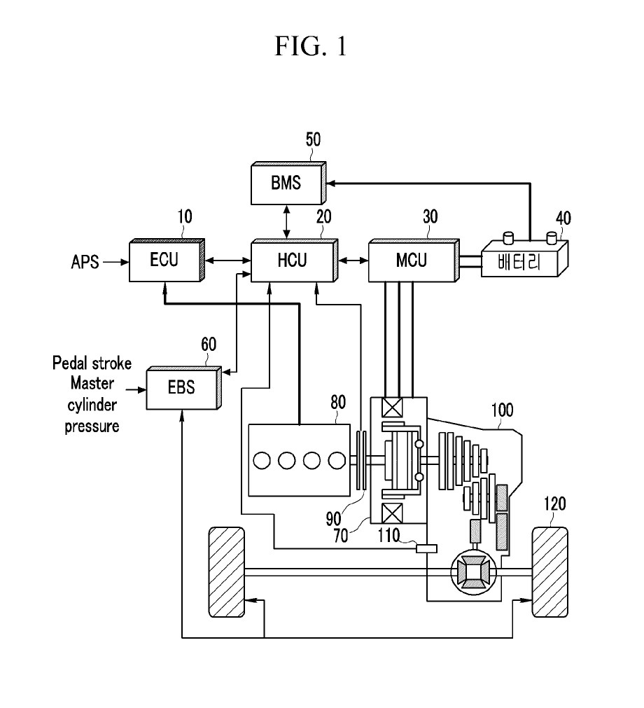

Referring now to FIG. 1, there is shown a regenerative braking torque compensation device 210 and a hybrid vehicle 200 according the present invention.

Such a hybrid vehicle 200 and regenerative braking torque compensation device 210 includes an Engine Control Unit (ECU) 10, a Hybrid Control Unit (HCU) 20, a Motor Control Unit (MCU) 30, a battery 40, a Battery Management System (BMS) 50, an Electric Brake System (EBS) 60, a motor 70, an engine 80, an engine clutch 90, a transmission 100, a vehicle speed detector 110, and a wheel 120.

As is known to those skilled in the art, the motor 70 is a motor generator that in one operating mode operates as a motor to provide power and torque to assist the engine and in another operating mode it functions as a generator so as to cause regenerative braking of the vehicle. As also indicated herein, the engine 80 is any of a number of engines known to those skilled in the art, or hereinafter developed that utilize any of a number of combustible materials to generate power or torque.

The ECU 10 is connected to the HCU 20 through a network, and controls the overall operations of the engine 80 together with the HCU 20.

In further embodiments, the HCU 20 and the ECU 10 control each device through a network depending on a driving demand and a vehicle condition, control the output torque of the engine 80 and the motor 70, calculate a regenerative braking amount according to a braking demand detected from the EBS 60, control the braking torque of the motor 70 through the MCU 30, subtract the regenerative braking amount from the total braking amount to calculate a remaining braking amount, and apply hydraulic pressure or the like to the vehicle breaks corresponding to the remaining braking amount for vehicle braking.

In yet further embodiments, the HCU 20 applies a present synchronized shift step to calculate the regenerative braking amount. If gear shifting also is occurring during the regenerative braking, the HCU 20 applies a target shift step and a shift phase to calculate a regenerative braking compensation amount, and adjusts the regenerative braking amount of the motor 70 through the MCU 30.

In yet further embodiments, during regenerative braking the MCU 30 controls the operating torque of the motor 70 according to the demand of the HCU 30, and charges the battery 40 with electricity generated from the motor 70.

The battery 40 supplies electricity to the motor 70 in a hybrid mode (HEV) and a motor mode (EV). In addition, the battery is charged with the electricity generated by the motor 70 during the regenerative braking control.

The BMS 50 detects a voltage, a current, and a temperature of the battery 40, manages SOC (state of charge), charging, and discharging, and offers the HCU 20 pertinent information through a network.

In further embodiments, when a driver operates the brakes of the vehicle, the EBS 60 calculates a braking torque from the pedal stroke and the hydraulic pressure of a master cylinder and controls a hydraulic pressure supplied to the brake cylinder of each wheel 120 depending on the braking torque.

The output torque of the motor 70 is controlled by the MCU 30.

The output of the engine 80 is controlled by the ECU 20, and an intake air amount of the engine 80 is adjusted by an electric throttle controller (ETC) as is known to those skilled in the art (ETC non-illustrated).

The engine clutch 90 is disposed between the engine 80 and the motor 70 and is operated according to the HCU 20 to determine the driving mode.

In further embodiments , the transmission 100 is an automatic type of transmission as are known to those killed in the art or hereinafter developed that shifts gears to a target step according to driving conditions such as vehicle speed, throttle opening rate, input torque, and so on so as to sustain adequate vehicle speed.

The speed detector 110 detects vehicle speed from a rotation velocity of an output shaft of the transmission and transfers the velocity information to the EBS 60.

According to another aspect of the present invention, for a hybrid vehicle performing the above functions, the following described procedure(s) are used to compensate for the regenerative braking torque.

The details regarding control operations of the hybrid vehicle according to the driving conditions are omitted, and the method for compensating a regenerative braking torque is explained in the following.

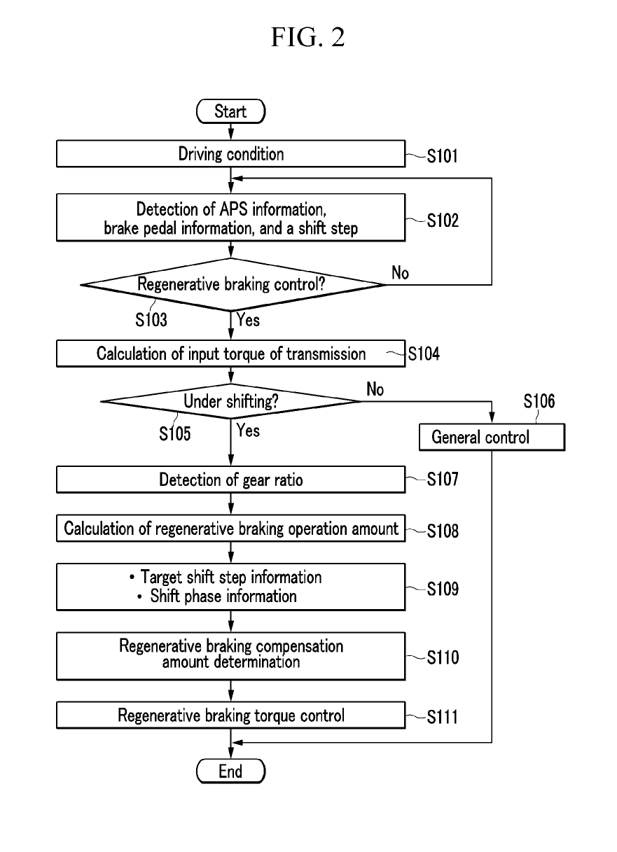

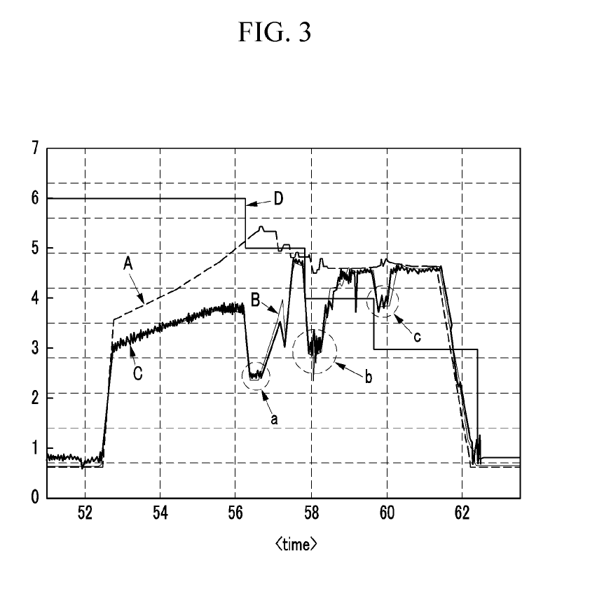

There is shown in FIG. 2 a high level flow diagram showing a methodology according to the present invention for compensating for regenerative braking torque in a hybrid vehicle, and FIG. 3 shows a regenerative braking torque compensation result of a hybrid vehicle according to the present invention.

In the driving process (Step S101), in which the hybrid vehicle moves at a predetermined shift step according to the present invention, the HCU 20 detects an Accelerator Pedal Switch (APS) condition, brake pedal information, and shift step information from a control device connected through a network in the vehicle (Step S102), and analyzes the detected information so as to determine whether regenerative braking control is demanded or not (Step S103).

If it is determined that the regenerative braking control is not necessary (No, Step 103), the present driving condition is sustained, and if it is determined that the regenerative braking control is necessary (Yes, Step S103), an input torque of the transmission 100 is calculated by adding a motor output torque of the motor 70 to an engine output torque of the engine 80 (Step S104).

Further, the information of the transmission 100 is detected through a TCU (not illustrated), and it is determined whether up/down gear shifting is being operated during the regenerative braking (Step S105).

If the up/down shifting is not performed (No, Step S105), the regenerative braking torque is determined by applying the input torque and gear ratio of the transmission 100, a creep torque amount of the motor 70, and efficiency of the transmission 100.

Thereafter, the determined regenerative braking torque is applied by the motor 70 controlled through the MCU 30, and the hydraulic pressure is simultaneously applied to the brake cylinder of the wheel 120 through the EBS 60 so as to brake (Step S106).

However, if it is determined that the up/down shifting according to the velocity increase/decrease of the vehicle is to be performed (Yes, Step S105), a real gear ratio is detected between the input rotation speed of the transmission 100 inputted through the engine clutch 90 and the vehicle speed detected by the speed detector 110 (Step S107).

A real shift gear ratio detected in Step S107 and an efficiency of the transmission 100 are applied to an input torque of the transmission 100 detected (Step S104) to calculate a regenerative braking amount (Step S108).

Further, the information of a target shift step and a shift phase are detected and the compensation amount of the regenerative braking is determined (Step S109), the compensation amount is applied to the regenerative braking amount predetermined (Step S108) to determine a final regenerative braking torque amount. The final regenerative braking torque is applied by the motor 70 through the MCU 30, and the hydraulic pressure is applied to the brake cylinder of the wheel 120 (Step S111).

Accordingly, in a case that the up/down shifting is performed during the regenerative braking control, the real gear ratio and the shift phase of the target shift step are considered to compensate the regenerative braking torque such that excessive braking does not occur, the stability and reliability of driving are enhanced, and the brake torque is continuously formed.

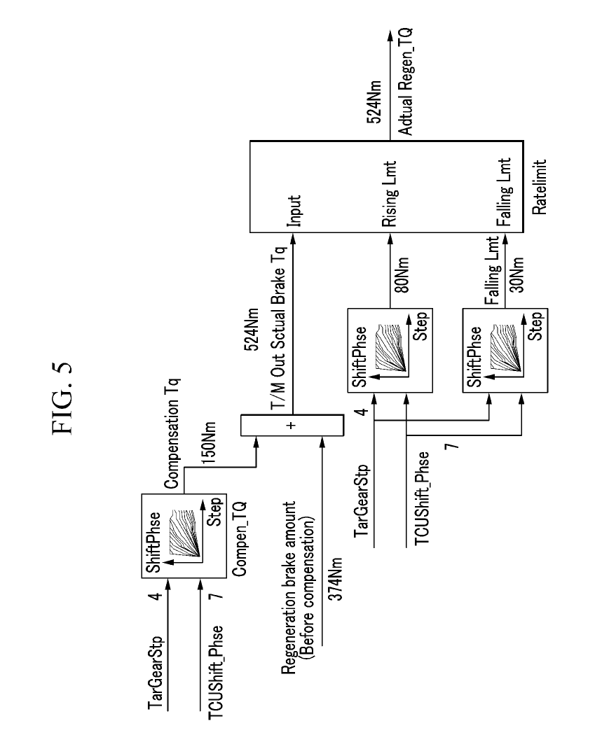

Referring now to FIG. 5, there is shown a procedure for realizing a regenerative braking torque compensation result according to another embodiment of the present invention.

Referring to FIG. 5, the target gear step (TarGearStp) 4 and the shift phase (TCUshift_Phse) 7 are inputted, and a compensation torque (Tq) of 150 Nm is calculated.

In further embodiments, data for a gear step 4 and a shift phase 7 are stored beforehand through a torque sensor as experimental values.

Further, the compensation torque of 150 Nm and the regenerative brake amount 374 Nm are added to make a real regenerative braking amount 524 Nm.

In such an embodiment, the error range of the torque between the target gear step (TarGearStp) 4 and the shift phase (TCUshift_Phse) 7 are additionally calculated.

In yet further embodiments, it is desirable that the next variation size of the torque ranges from −30 Nm to +80 Nm based on a reference value such that the regenerative braking amount is not abruptly changed.

That is, in a case that the present compensated regenerative braking size is 524 Nm, the next compensated regenerative braking amount can range from 496 Nm to 604 Nm.

While the present invention has been described in detail with reference to the preferred embodiments, those skilled in the art will appreciate that various modifications and substitutions can be made thereto without departing from the spirit and scope of the present invention as set forth in the appended claims.

What is claimed is:

1. A regenerative braking torque compensation device of a hybrid vehicle, comprising:
a motor control unit controlling operation torque of a motor;
a brake control unit calculating a brake torque to control hydraulic pressure supplied to a brake cylinder of a wheel; and
a hybrid control unit that applies a real shift ratio to calculate a regenerative braking amount if gear shifting is detected, and determining a regenerative braking torque compensation amount according to a target shift step and a shift phase to control regenerative braking torque.

2. The regenerative braking torque compensation device of claim 1, wherein the hybrid control unit uses an input speed and an output speed of a transmission to calculate the real shifting ratio.

3. The regenerative braking torque compensation device of claim 1, wherein the hybrid control unit applies engine torque transferred through a motor and an engine clutch to calculate a regenerative braking operation amount.

4. A regenerative braking torque compensation method of a hybrid vehicle, comprising:
(a) a step of determining a regenerative braking operation amount to control regenerative braking torque while regenerative braking is needed;
(b) a step of applying a real shift ratio to determine a regenerative braking operation amount if shifting is detected during the regenerative braking;
(c) a step of applying a target shift step and a shift phase according to the shifting to decide a regenerative braking compensation amount; and
(d) a step of applying the regenerative braking operation amount to the regenerative braking compensation amount to control a final regenerative braking torque.

5. The regenerative braking torque compensation method of claim 4, wherein the regenerative braking operation amount of the (a) step is calculated by motor torque, engine torque transferred through an engine clutch, a shifting ratio, motor creep torque, and transmission efficiency.

6. The regenerative braking torque compensation method of claim 4, wherein the real shifting ratio operated during the regenerative braking of the (b) step is calculated by the input speed and the output speed of the transmission.

7. A regenerative braking torque compensation device for a hybrid vehicle, comprising:
a motor control unit being configured so as to control the operation torque of a motor;
a brake control unit being configured to calculate a brake torque which is used to control hydraulic pressure supplied to a brake cylinder of a wheel; and
a hybrid control unit being configured to calculate a regenerative braking amount when gear shifting is detected during regenerative braking, and to determine a regenerative braking torque compensation amount used to establish a regenerative braking torque.

8. A regenerative braking torque compensation method of a hybrid vehicle, comprising the step(s) of:
(a) determining a regenerative braking operation amount to control regenerative braking torque during regenerative braking;
(b) if transmission shifting is detected during regenerative braking, determining a regenerative braking operation amount;
(c) applying a target shift step and a shift phase to determine a regenerative braking compensation amount; and
(d) applying the regenerative braking operation amount to the regenerative braking compensation amount to determine a final regenerative braking torque.

9. A hybrid vehicle comprising:
an engine;
an electric motor being operably coupled to an output of the engine so as to at least assist the engine during operation of the vehicle and being capable of regenerative braking; and
a regenerative braking torque compensation device that includes:
a motor control unit being configured so as to control the operation torque of a motor;
a brake control unit being configured to calculate a brake torque which is used to control hydraulic pressure supplied to a brake cylinder of a wheel; and
a hybrid control unit being configured to calculate a regenerative braking amount when gear shifting is detected during regenerative braking, and to determine a regenerative braking torque compensation amount used to establish a regenerative braking torque.
